(19) United States
(12) Patent Application Publication
(10) Pub. No.: US 2002/0130894 A1
(43) Pub. Date: Sep. 19, 2002

(54) Web page character

(76) Inventors: Christopher I. Young, Waltham, MA (US); Michael M. Langlie, Belmont, MA (US)

Correspondence Address: PAUL A. PYSHER, Fish & Richardson P.C., 225 Franklin Street, Boston, MA, 02110-2804, US

(21) Appl. No.: 09/809,618

(22) Filed: Mar. 15, 2001

(51) Int. Cl. G06F 3/00

(52) U.S. Cl. 345/706; 345/764

(57) ABSTRACT

A computer-implemented system includes generating a character and an object on a portion of a World Wide Web page, causing the character to interact with the object in response to a user input, and controlling movement of the character based on identities of the character and the object. An environment, such as a room, may also be generated for the character and the object. The environment houses the character and the object.

### TECHNICAL FIELD

This invention relates to generating, and interacting with, an animated character on a World Wide Web page.

### BACKGROUND

The World Wide Web (or simply “Web”) component of the Internet links Web pages through HTTP (HyperText Transfer Protocol). A user viewing a Web page can simply point and click on a hyperlink to call-up another Web page.

A Web browser, such as Microsoft© Internet Explorer© or Netscape© Navigator©, allows a user to access the Web. Web browsers provide a graphical user interface (GUI), through which the user can view, and link to, various Web pages. Some Web pages install small programs, called “cookies”, in Web browsers. Cookies enhance the interaction between the Web browser and Web pages.

### SUMMARY

In general, in one aspect, the invention features generating a character and an object on a portion of a World Wide Web page, causing the character to interact with the object in response to a user input, and controlling movement of the character based on identities of the character and the object. This aspect of the invention may include one or more of the following features.

An environment may be generated for the character and the object. The environment may house the character and the object and may include an element. An action may be performed in the environment in response to a user input that relates to the element. The action may include moving the element, moving another element in the environment, providing the object, and/or moving the character.

The object may be retrieved from a second World Wide Web page. The retrieving process may include linking to the second World Wide Web page using a Web browser and storing data for the object in a cookie on the Web browser. The object may be generated from the data in the cookie. The second World Wide Web page may contain a second environment that houses the object. The World Wide Web page may be maintained by a first user and the second World Wide Web page may be maintained by a second user.

Other features and advantages of the invention will become apparent from the following description, including the claims and drawings.

### BRIEF DESCRIPTION OF THE DRAWINGS

FIG. 1 is a view of a computer network.

FIGS. 2 and 3 are flowcharts showing processes for providing an animated character on a Web page.

FIGS. 4 to 10 show examples of the animated character.

FIGS. 11 to 17 show examples of environments for the animated character.

### DESCRIPTION

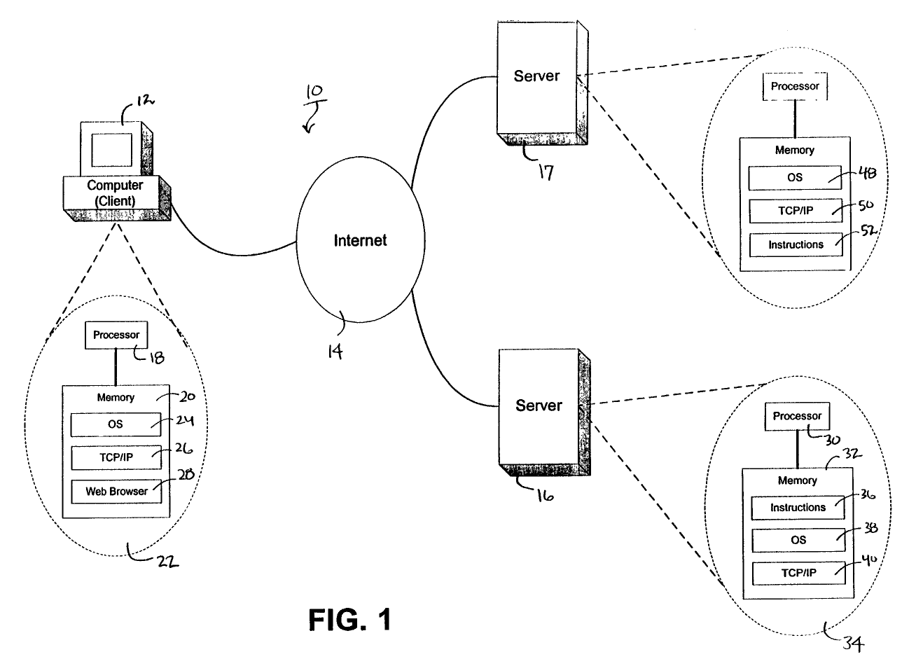

FIG. 1 shows a network 10. Network 10 includes a computer 12, such as a personal computer (PC). Computer 12 is connected to a network 14, such as the Internet, that runs TCP/IP (Transmission Control Protocol/Internet Protocol) or another suitable protocol. Connections may be via Ethernet, wireless link, telephone line, or the like. Various servers 16 and 17 are also connected to network 14. These servers may be mainframe computers, PCs, or any other type of processing device. The servers host Web pages that are accessible by computer 12 (i.e., client).

Computer 12 contains a processor 18 and a memory 20 (see view 22). Memory 20 stores an operating system (OS) 24 such as Windows98®, a TCP/IP protocol stack 26 for communicating over network 14, and a Web browser 28 such as Internet Explorer® or Netscape® Navigator®, for accessing Web pages hosted by servers 16 and 17 via network 14.

Server 16 contains a processor 30 and a memory 32 (see view 34). Memory 32 stores machine-executable instructions 36, OS 38, and TCP/IP protocol stack 40. Instructions 36 are executed by processor 30 to host a Web page maintained by a user at computer 12, and to perform processes 44 and 46 below. That is, a user at computer 12 uses Web browser 28 to access server 16, which, in response, executes instructions 36 to perform processes 44 and 46. Server 17 contains similar software to server 16, i.e., OS 48, TCP/IP protocol stack 50, and machine-executable instructions 52. Instructions 52 are used to host a different Web page maintained by a second user. It is noted that both Web pages, i.e., the Web pages hosted by servers 16 and 17, could be hosted by the same server.

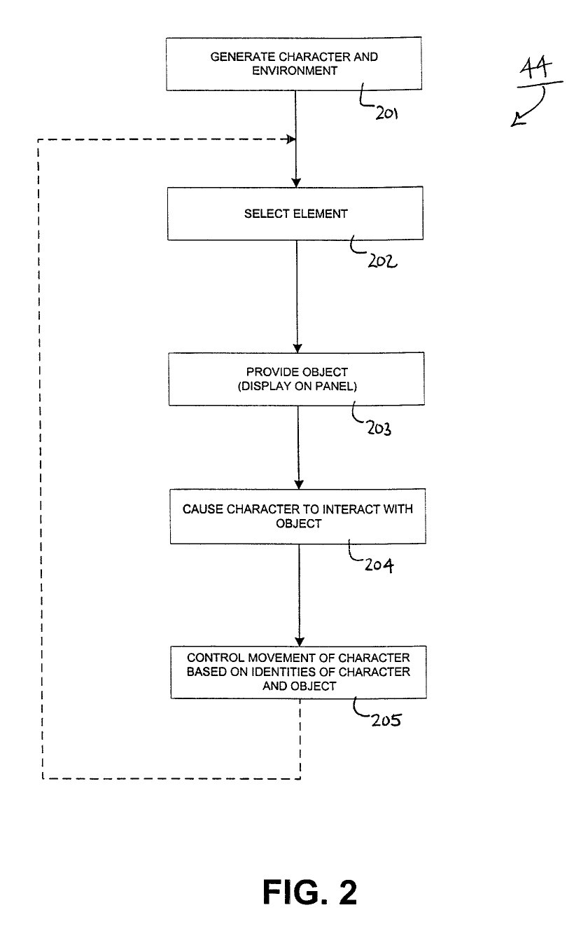

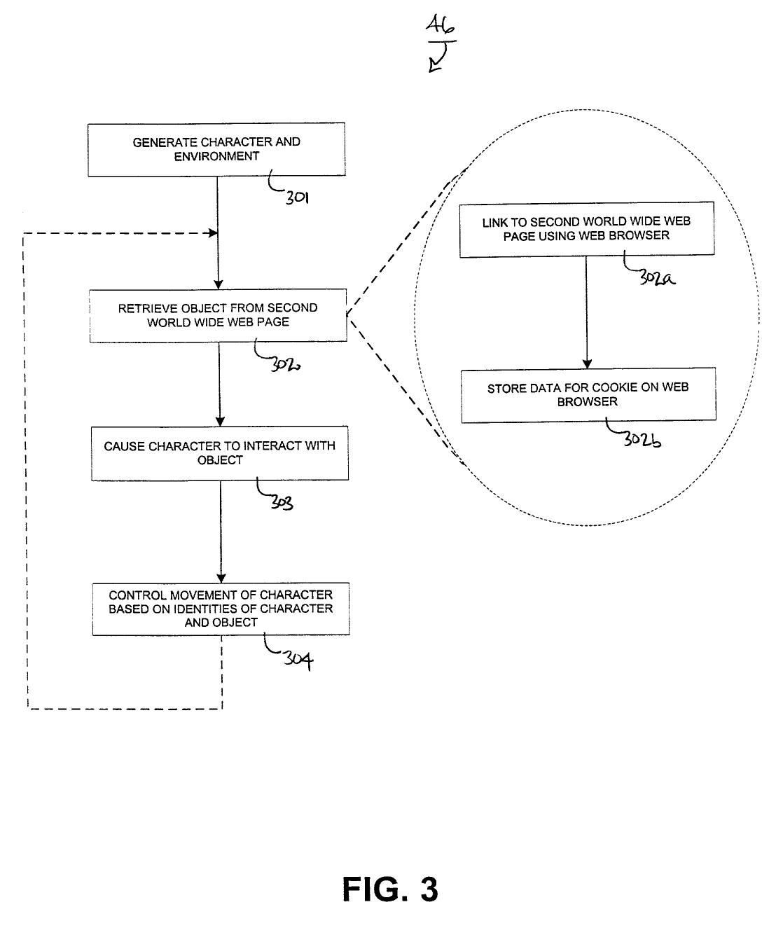

Referring to FIGS. 2 and 3, processes 44 and 46 are shown for providing an animated character, called a “Mycrobe™”, on a Web page. The character and environment may be generated as a Shockwave file using software, such as Macromedia Director. Shockwave and Director were developed by Macromedia, Inc. and enable Web pages to include multimedia objects. Shockwave is used to create animated characters that respond to user actions such as mouse clicks. It is noted that the character can be created using software other than Shockwave, or using a combination of Shockwave and other software.

The character is placed in an “environment”, e.g., a room, which takes up a portion, of a user's Web page. The environment is a simulated three-dimensional (3D) space using one-point perspective (e.g., a cartoon simulation of a 3D room using one-point perspective) that contains various objects (e.g., “toys”) that the character can interact with, along with elements that either the user or the character can select. Selecting elements causes instructions 36 to move the elements and, as a reward, provide the user with objects.

A certain number of objects may be provided in the environment when the environment is generated. Other objects may be retrieved from other Web pages by visiting the other Web pages. That is, a user may link to those other Web pages through a GUI, described below, locate other objects and bring them into the environment.

Processes 44 and 46 may be implemented using HTML (HyperText Mark-up Language) code in the machine-executable instructions 36 that generate the user's Web page. The user may retrieve the HTML code necessary to implement processes 44 and 46 from a “warehousing” Web site (not shown), which provides the code based, e.g., on the type of character and environment that the user wants displayed on their Web page. That is, the user can link to the warehousing Web site, copy HTML code from that site for a desired character and environment, and paste the copied HTML code into an appropriate location in the instructions 36 that generate the user's Web site. When the instructions 36 are executed, the desired character and environment are displayed on the user's Web page.

In this embodiment, the user may select from a variety of characters and environments. Each environment has associated with it specific objects (toys) and elements. Different characters may interact with different objects in the same, or in different, ways. That is, different characters may have different responses to the same object. These reactions are programmed into the character in the HTML code copied from the warehousing site.

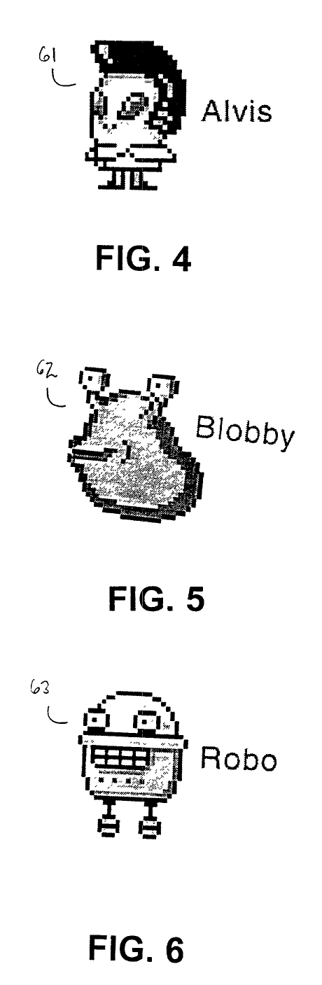

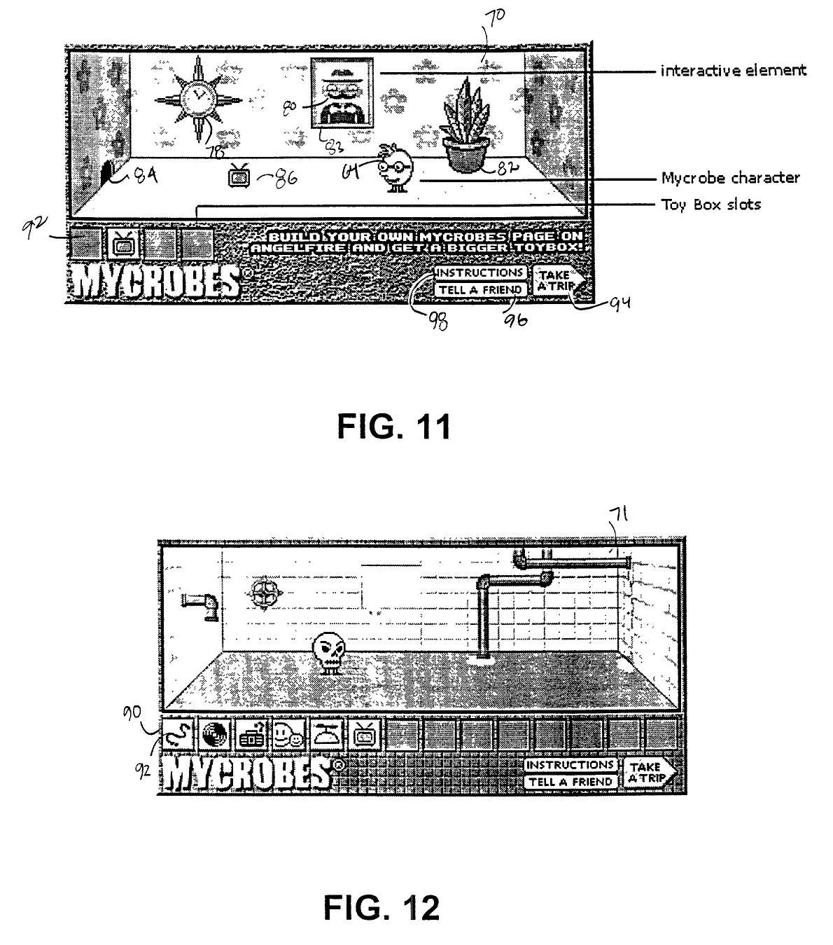

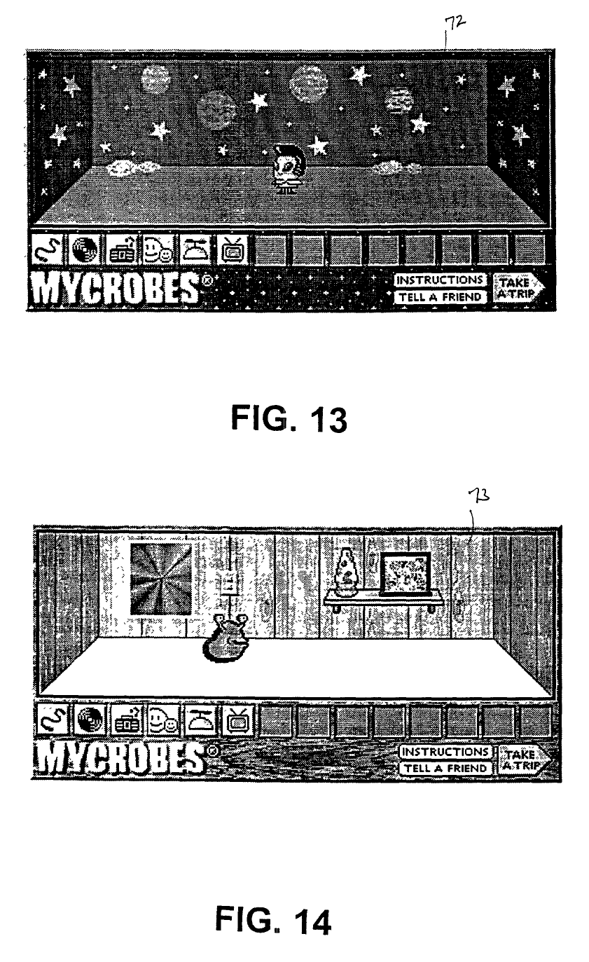

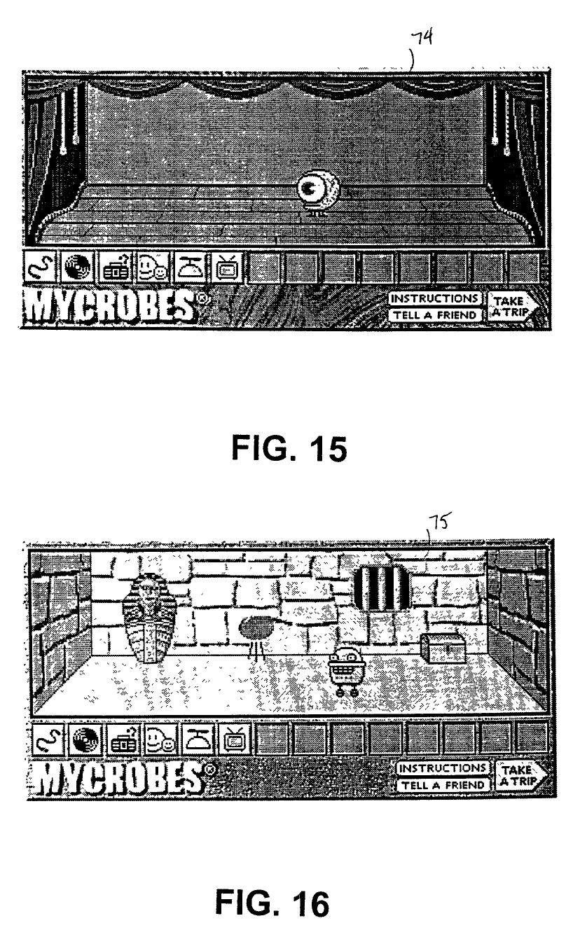

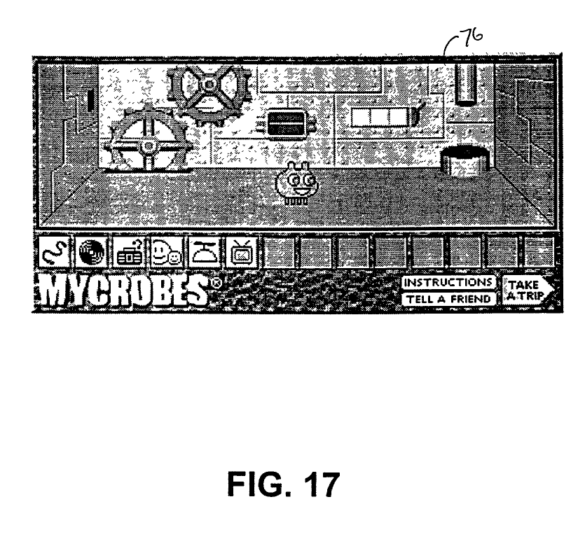

Referring to FIGS. 4 to 10, this embodiment allows a user to select from seven different characters 61 to 67, whose names are shown alongside their images. Referring to FIGS. 11 to 17, this embodiment also allows the user to select from seven different environments 70 to 76. Each environment contains its own unique interactive elements and objects. For example, environment 70 contains elements 78, 80, 82 and 84 and object 86. Objects may be added to environments by visiting other environments (i.e., by visiting other Web pages), as described below.

Generally speaking, there is no visual difference in the environments between elements and objects. Their difference lies in how the user and character interacts with them. That is, generally, the elements are programmed to react to user inputs (e.g., pointing and clicking using a mouse). For example, if a user clicks on moustache 80 in FIG. 11, moustache 80 leaves painting 83 and flies around the room. The characters are programmed to have a particular reaction to the objects, as described below. Of course, the invention is not limited to this. For example, elements may be programmed to react to characters and objects may be programmed to react to user inputs.

Referring to FIG. 12, objects that may be present in an environment are displayed on a panel 90, which includes “toy slots” and, optionally, a banner (not shown) containing advertisements that refresh periodically. In this embodiment, when an environment is first generated, a predetermined number of objects can be obtained (e.g., discovered, uncovered, located, etc.) from within the environment itself. As described below, this is done in response to the user interacting with the various elements in the environment. As each object is obtained, it is placed in a toy slot 92 on panel 90. The user can activate an object by clicking on the object. Activating an object causes that object to be displayed in the environment.

When other objects are retrieved from other environments, e.g., other Web pages, those other objects are also displayed in the toy slots. If there are not enough toy slots to accommodate the other objects, the new (retrieved) objects take the place of selected old objects. A user can increase the number of toy slots on the user's panel by rewriting the HTML code that generates the relevant environment. As above, clicking on an object in a toy slot activates that object.

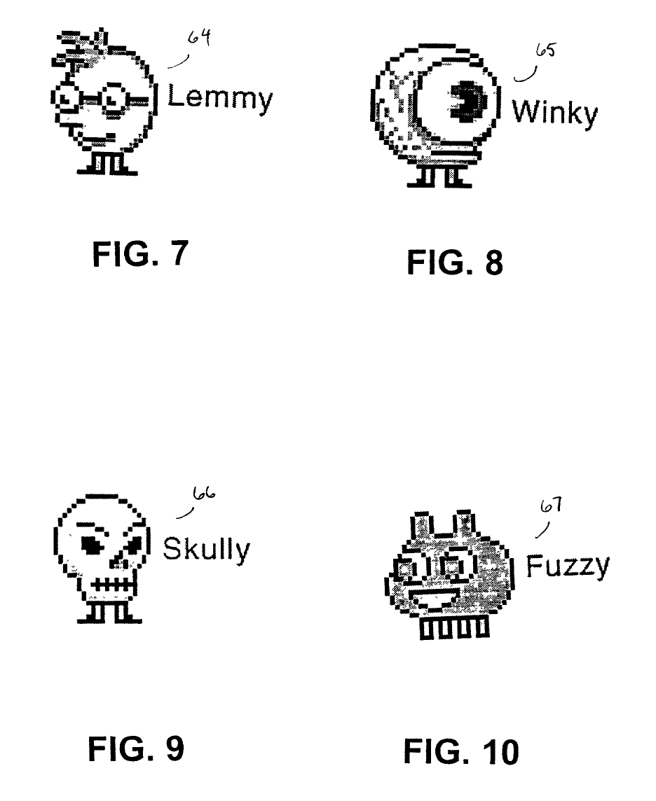

A character can interact with active objects in an environment. To make a character interact with an object, the user can drag-and-drop the character onto the object or vice versa. In response, the character is programmed to react based on its own identity and the identity of the object with which it is interacting. For example, if Skully 66 (FIG. 9) interacts with television 86 (FIG. 11), Skully 66 might perform a dance routine. On the other hand, if Lemmy 66 (FIGS. 7 and 11) interacts with television 86, Lemmy 64 might run in the other direction. The reaction of each character to the same object thus may be unique. Each character may perform its own unique actions or, alternatively, each character may be able to perform the same actions as any other character, just in response to different stimuli.

Referring to FIG. 11, options 94, 96, and 98 are also provided to the user. Option 98, “INSTRUCTIONS”, provides the user with instructions on how to use the character (Mycrobe™) and environment. Option 96, “TELL A FRIEND”, links the user to another Web page (not shown). Through this other Web page, the user can send electronic mail (e-mail) messages to others informing them of the Mycrobes™. Such e-mail messages may be pre-populated with information, such as the URL (Uniform Resource Locator) of a Web page the user is referring to, instructions on how to use the Mycrobes™ feature, and instructions on how to build Mycrobes™. Using this option may cause the computer program that generates the character and its environment to provide additional “bonus” objects to the user's character.

Option 94, “TAKE A TRIP”, links the user to another, random, Web page. For example, clicking on option 94 will cause instructions 36 to randomly select another Web page (e.g., the second Web page generated by server 17) that contains Mycrobes™. Server 16, or another server on the Internet that can be accessed by server 16, may store a database of such pages. The user is provided the second Web page via HTTP. The user's character does not accompany the user, however. The second Web page is maintained by another user. On this other Web page, the user is given access to another environment and character.

The user can perform basically the same functions on the second Web page as on the other own Web page. That is, the user can select elements, locate objects, and cause the character displayed on the second Web page to interact with objects. Data for each object that is located on the second Web page is stored in a cookie on the user's Web browser. When the user returns to his own Web page, e.g., by hitting the “back” browser button, the cookie causes objects retrieved from the second Web page to be displayed in the toy slots on the user's environment.

Referring to FIG. 2, a process 44 is shown, which is implemented by instructions 36, to generate and display a character and environment, such as those shown in FIGS. 4 to 10 and 11 to 17. Process 44 is directed to finding objects on a user's home Web page. Process 44 generates (201) a character and an environment. The environment houses the character and includes elements and objects like those described above. A user selects (202) an element in the environment and, in response to the user input, process 44 performs an action in the environment.

The action may include moving the element, such as causing moustache 80 (FIG. 11) to fly around the room. The action may include moving another element in the environment. For example, a user clicking on mouse hole 84 (FIG. 11) causes a mouse (not shown) to appear and run around the room. The action may include providing the object. For example, clicking on plant 82 (FIG. 11) may cause an object, such as television 86, to fall out of the sky. The action may include moving the character in response to selecting the element. Other types of actions also may be performed. For example, clicking on an element might cause the element to move to reveal an object or to change into an object.

Whatever the case, selecting an element provides (203) an object (toy) with which the character can interact. As noted, the object is stored initially in a toy slot 92, until the object is activated by the user. Activation may be performed by pointing and clicking on the object in the toy slot with a mouse or other computer input device, as noted above. Once an object is activated, it is also displayed in the environment, such as television 86 in FIG. 11. A user dragging-and-dropping the character onto the object, or the object onto the character, causes (204) the character and the object to interact. Alternatively, positioning the object and character within a predetermined proximity of one another, or at marked locations in the environment, may also cause an interaction.

The interaction between the character and the object triggers a reaction. What is meant by “reaction” is that process 44 controls (205) movement of the character based on the identities of the character and the object. As described above, different characters may have different reactions to the same object. Therefore, process 44 recognizes the identity of the object and the character based, e.g., on identification information in the HTML code that generated the character and object, and controls the movement of the character accordingly. Examples of character movements are described above.

Blocks 202 to 205 of process 44 may be repeated as desired by the user, hence the dotted line in FIG. 2.

FIG. 3 shows a process 46 that is similar to process 44, except that process 46 is directed more towards retrieving objects from other Web pages. Process 46 generates (301) a character and an environment, including elements and objects, in the same way as process 44. Process 46, however, retrieves (302) “foreign” objects from one or more other Web pages and imports those foreign to the user's home Web page. What is meant by “foreign” here is that the objects originated from a Web page other than the user's Web page. Use of the term “foreign” is not meant to imply that the objects are necessarily different in structure and/or function from those that were originally generated on the user's home Web page.

Process 46 retrieves (302) a foreign object by linking (302a) to another Web page (not shown). In the embodiment described herein, process 46 links to a random Web page that also has a character and that is registered with a central server or whose URL can be obtained via peer-to-peer communication between servers. Linkage is initiated by the user clicking on option 94 (e.g., FIG. 11).

Once at the other Web page, the user interacts with elements on the other Web page in much the same way that the user interacts with the elements on the user's home Web page. As the user locates objects (toys) on the other Web page, data for recreating those toys is stored (302b) in cookie(s) on the user's Web browser. When the user returns to the user's home Web page, process 46 retrieves the data in the cookie(s) and generates the appropriate objects on the user's home Web page. As in process 44, the objects are stored initially in toy slots 92 in panel 90 (see, e.g., FIG. 12) until activation.

Thereafter, the remainder of process 46, namely blocks 303 and 304 is identical to blocks 204 and 205 of process 44. Following block 304, blocks 302 to 304 may be repeated by the user as desired, hence the dotted line in FIG. 3.

It is noted the processes 44 and 46 may be used in combination with the same character and environment. Blocks of processes 44 and 46 may be re-arranged as desired. For example, a user may locate several objects on the user's home Web page according to process 44. The user may then locate several objects on another user's Web page according to process 46. Then, when all objects have been located, the user may cause the objects to interact with the user's character. Thus, FIGS. 2 and 3 merely show two specific ways to implement the invention. The order of the blocks is merely representative and not limiting.

In this regard, processes 44 and 46 are not limited to use with the hardware/software configuration of FIG. 1, they may find applicability in any computing or processing environment. Processes 44 and 46 may be implemented in hardware (e.g., an ASIC {Application-Specific Integrated Circuit} and/or an FPGA {Field Programmable Gate Array}), software, or a combination of hardware and software.

Processes 44 and 46 may be implemented using one or more computer programs executing on programmable computers that each includes a processor, a storage medium readable by the processor (including volatile and non-volatile memory and/or storage elements), at least one input device, and one or more output devices.

Each such program may be implemented in a high level procedural or object-oriented programming language to communicate with a computer system. Also, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform processes 44 and 46.

Processes 44 and 46 may also be implemented as a computer-readable storage medium, configured with a computer program, where, upon execution, instructions in the computer program cause the computer to operate in accordance with processes 44 and 46.

The invention is not limited to the specific embodiments described here. For example, the invention is not limited to use in a World Wide Web context. It may be used with any graphical user interface on any network. The invention is not limited to use with the particular graphics displays shown in FIGS. 4 to 10 and 11 to 17. Any graphical displays may be generated. The invention can also be modified so that characters themselves interact with one another, if desired.

Other embodiments not described herein are also within the scope of the following claims.

What is claimed is:

1. A computer-implemented method comprising:
generating a character and an object on a portion of a World Wide Web page;
causing the character to interact with the object in response to a user input; and
controlling movement of the character based on identities of the character and the object.

2. The method of claim 1, further comprising:
generating an environment for the character and the object, the environment housing the character and the object and including an element.

3. The method of claim 2, further comprising:
performing an action in the environment in response to a user input that relates to the element.

4. The method of claim 3, wherein the action comprising moving the element.

5. The method of claim 3, wherein the action comprises moving another element in the environment.

6. The method of claim 3, wherein the action comprises providing the object.

7. The method of claim 3, wherein the action comprises moving the character.

8. The method of claim 1, further comprising:
retrieving the object from a second World Wide Web page.

9. The method of claim 1, wherein retrieving comprises:
linking to the second World Wide Web page using a Web browser; and
storing data for the object in a cookie on the Web browser.

10. The method of claim 9, wherein the object is generated from the data in the cookie.

11. The method of claim 9, wherein the second World Wide Web page contains a second environment that houses the object.

12. The method of claim 1, wherein the World Wide Web page is maintained by a first user and the second World Wide Web page is maintained by a second user.

13. A graphical user interface (GUI) on a World Wide Web page, the GUI comprising:
an environment containing an object;
an animated character capable of interacting with the object and of obtaining additional objects; and
a panel which displays the object.

14. The GUI of claim 13, further comprising:
an element housed in the environment, the element for triggering an action within the environment.

15. The GUI of claim 14, wherein the action comprising moving the element.

16. The GUI of claim 14, wherein the action comprises moving another element in the environment.

17. The GUI of claim 14, wherein the action comprises providing the object.

18. The GUI of claim 14, wherein the action comprises moving the character.

19. The GUI of claim 13, further comprising a banner containing advertisements that refresh periodically.

20. A computer program stored on a computer-readable medium, the computer program comprising instructions that cause a machine to:
generate a character and an object on a portion of a World Wide Web page;
cause the character to interact with the object in response to a user input; and
control movement of the character based on identities of the character and the object.

21. The computer program of claim 20, further comprising instructions that cause the machine to:
generate an environment for the character and the object, the environment housing the character and the object and including an element.

22. The computer program of claim 21, further comprising instructions that cause the machine to:
perform an action in the environment in response to a user input that relates to the element.

23. The computer program of claim 22, wherein the action comprising moving the element.

24. The computer program of claim 22, wherein the action comprises moving another element in the environment.

25. The computer program of claim 22, wherein the action comprises providing the object.

26. The computer program of claim 22, wherein the action comprises moving the character.

27. The computer program of claim 20, further comprising instructions that cause the machine to:
retrieve the object from a second World Wide Web page.

28. The computer program of claim 20, wherein retrieving comprises:
linking to the second World Wide Web page using a Web browser; and
storing data for the object in a cookie on the Web browser.

29. The computer program of claim 28, wherein the object is generated from the data in the cookie.

30. The computer program of claim 28; wherein the second World Wide Web page contains a second environment that houses the object.

31. The computer program of claim 20, wherein the World Wide Web page is maintained by a first user and the second World Wide Web page is maintained by a second user.

32. An apparatus comprising:
a memory which stores executable instructions; and
a processor which executes the instructions to:
generate a character and an object on a portion of a World Wide Web page;
cause the character to interact with the object in response to a user input; and
control movement of the character based on identities of the character and the object.

33. The apparatus of claim 32, wherein the processor executes instructions to:
generate an environment for the character and the object, the environment housing the character and the object and including an element.

34. The apparatus of claim 33, wherein the processor executes instructions to:
perform an action in the environment in response to a user input that relates to the element.

35. The apparatus of claim 34, wherein the action comprises moving the element.

36. The apparatus of claim 34, wherein the action comprises moving another element in the environment.

37. The apparatus of claim 34, wherein the action comprises providing the object.

38. The apparatus of claim 34, wherein the action comprises moving the character.

39. The apparatus of claim 32, wherein the processor executes instructions to:
retrieve the object from a second World Wide Web page.

40. The apparatus of claim 32, wherein retrieving comprises:
linking to the second World Wide Web page using a Web browser; and
storing data for the object in a cookie on the Web browser.

41. The apparatus of claim 40, wherein the object is generated from the data in the cookie.

42. The apparatus of claim ⁴0., wherein the second World Wide Web page contains a second environment that houses the object.

43. The apparatus of claim 32, wherein the World Wide Web page is maintained by a first user and the second World Wide Web page is maintained by a second user.
